(19) United States
(12) Patent Application Publication
(10) Pub. No.: US 2007/0165510 A1
(43) Pub. Date: Jul. 19, 2007

(54) Optical disc apparatus, optical pickup apparatus, and method for reducing astigmatism

(75) Inventor: Kenji Yamamoto, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/648,559

(22) Filed: Jan. 3, 2007

(30) Foreign Application Priority Data
Jan. 13, 2006 (JP) 2006-005646
May 11, 2006 (JP) 2006-132934

(51) Int. Cl. G11B 7/00

(52) U.S. Cl. 369/112.28; 369/112.01

(57) ABSTRACT

An optical disc apparatus includes a light source that emits a laser beam; a collimator lens arranged on an optical axis of the emitted laser beam; a upward directing prism that changes the direction of the optical axis of the laser beam output from the collimator lens by approximately 90°, the upward directing prism having a beam-shaping magnification β in the range of 0.97<β<1.03; an objective lens that condenses the laser beam on an optical disc having a protective layer with a thickness error range of 12.5 μm after the direction of the optical axis is changed by the upward directing prism, the objective lens having a numerical aperture NA of 0.85; and a unit for changing an angle of divergence or convergence of the laser beam incident on the objective lens.

### CROSS REFERENCES TO RELATED APPLICATIONS

The present invention contains subject matter related to Japanese Patent Applications JP 2006-005646 filed in the Japanese Patent Office on Jan. 13, 2006 and JP 2006-132934 filed in the Japanese Patent Office on May 11, 2006, the entire contents of which are incorporated herein by reference.

### BACKGROUND OF THE INVENTION

1. Field of the Invention

The present invention relates to an optical disc apparatus and an optical pickup apparatus for optically recording and reproducing information on and from an optical disc, and also relates to an astigmatism reducing method that may be used in the optical disc apparatus and the optical pickup apparatus.

2. Description of the Related Art

Recently, the size of personal computers and the like has been reduced, and accordingly there has been a demand to reduce the size of optical disc apparatuses contained therein. To satisfy such a demand, a technique for reducing the thickness of an optical pickup apparatus by using a triangular upward directing prism, thereby reducing the size of an optical disc apparatus containing the optical pickup apparatus, has been suggested in, for example, U.S. Patent Application Publication No. 2003/0185137 (see paragraphs [0022] and [0056] and FIG. 3).

On the other hand, a Blu-ray disc (trademark; hereinafter abbreviated as BD) is used as an optical disc for high-density optical recording. In an optical pickup apparatus included in an optical disc apparatus for recording and reproducing information on and from a BD, as a method for correcting a spherical aberration, a laser beam having an angle of divergence or convergence is caused to be incident on an objective lens.

The triangular upward directing prism may be used in the optical pickup apparatus in which a laser beam having an angle of divergence or convergence is caused to be incident on the objective lens. However, in such a case, since a beam-shaping magnification of the upward directing prism in the X and Y directions (the optical axis direction is defined as Z direction) is reported to be in the range of 1.1 to 1.3 (see, for example, U.S. Patent Application Publication No. 2003/0185137), it is estimated that large astigmatism will occur (see, for example, U.S. Patent Application Publication No. 2004/0170109 (paragraph [0016])).

As described in U.S. Pat. No. 6,151,154 (line 61, col. 6 to line 16, col. 7), the astigmatism may be corrected using a liquid crystal device disposed on an optical axis of the laser beam incident on the objective lens.

### SUMMARY OF THE INVENTION

However, the structure described in U.S. Pat. No. 6,151,154 includes a relatively large number of components including the liquid crystal device and it is difficult to reduce the size of the apparatus.

On the other hand, in the field of Blu-ray discs (trademark), similar to the field of digital versatile discs (DVD), a technique for increasing the number of recordable layers is applied. In this case, the amount of correction of the spherical aberration differs between the layers. More specifically, the amount of correction of the spherical aberration for a first layer is different from that for a second layer. Therefore, it is difficult to reduce the astigmatism by applying the above-mentioned technique described in U.S. Pat. No. 6,151,154.

In light of the above-described situation, it is desirable to provide an optical disc apparatus having an optical pickup apparatus that includes a upward directing prism, that can dynamically correct a spherical aberration, that can reduce astigmatism without making it difficult to reduce the size of the apparatuses, and that can accurately record and reproduce information without redundancy.

An optical disc apparatus according to an embodiment of the present invention includes a light source that emits a laser beam; a collimator lens arranged on an optical axis of the emitted laser beam; a upward directing prism that changes the direction of the optical axis of the laser beam output from the collimator lens by approximately 90°, the upward directing prism having a beam-shaping magnification β in the range of 0.97<β<1.03; an objective lens that condenses the laser beam on an optical disc after the direction of the optical axis is changed by the upward directing prism, the optical disc having a protective layer with a thickness error range of 12.5 μm or less, the objective lens having a numerical aperture NA of 0.85; and a unit for changing an angle of divergence or convergence of the laser beam incident on the objective lens.

An optical pickup apparatus according to an embodiment of the present invention includes a light source that emits a laser beam; a collimator lens arranged on an optical axis of the emitted laser beam; a upward directing prism that changes the direction of the optical axis of the laser beam output from the collimator lens by approximately 90°, the upward directing prism having a beam-shaping magnification β in the range of 0.97<β<1.03; an objective lens that condenses the laser beam on an optical disc after the direction of the optical axis is changed by the upward directing prism, the optical disc having a protective layer with a thickness error range of 12.5 μm or less, the objective lens having a numerical aperture NA of 0.85; and a unit for changing an angle of divergence or convergence of the laser beam incident on the objective lens.

A method for reducing astigmatism according to an embodiment of the present invention includes the steps of emitting a laser beam from a light source; causing the emitted light beam to pass through a collimator lens and be incident on a upward directing prism having a beam-shaping magnification β in the range of 0.97<β<1.03; and changing an angle of divergence or convergence of the laser beam and condensing the laser beam on an optical disc via the upward directing prism and an objective lens, the optical disc having a protective layer with a thickness error range of 12.5 μm or less, the objective lens having a numerical aperture NA of 0.85.

According to the embodiments of the present invention, the beam-shaping magnification β is in the range of 0.97<β<1.03 in the optical pickup apparatus or the optical disc apparatus that includes the upward directing prism and that performs dynamic correction of a spherical aberration; Therefore, astigmatism can be reduced without making it difficult to reduce the size of the apparatuses, and information can be accurately recorded and reproduced without redundancy.

Preferably, a refractive index of the upward directing prism is 1.469, an angle between an entrance surface and an exit surface of the upward directing prism is 36°, an angle between the exit surface and a surface of the upward directing prism that is neither the entrance surface nor the exit surface is 36°, and an angle between the entrance surface and a plane perpendicular to the laser beam incident on the upward directing prism is 27°.

In such a case, the beam-shaping magnification β of the upward directing prism can be set within the range of 0.97<β<1.03 with respect to a blue laser beam.

Preferably, a wavelength of the laser beam emitted from the light source is 405 nm±10 nm.

In such a case, the effect obtained by setting the beam-shaping magnification β within the range of 0.97<β<1.03 becomes more significant.

The unit for changing the angle of divergence or convergence of the laser beam incident on the objective lens may include a mechanism for moving the collimator lens along the optical axis.

An optical disc apparatus according to another embodiment of the present invention includes a light source that emits a laser beam; a collimator lens arranged on an optical axis of the emitted laser beam; a upward directing prism that changes the direction of the optical axis of the laser beam output from the collimator lens by approximately 90°, the upward directing prism having a beam-shaping magnification β in the range of 0.94≦β≦1.06; an objective lens that condenses the laser beam on an optical disc after the direction of the optical axis is changed by the upward directing prism; and a unit for changing an angle of divergence or convergence of the laser beam incident on the objective lens.

An optical pickup apparatus according to another embodiment of the present invention includes a light source that emits a laser beam; a collimator lens arranged on an optical axis of the emitted laser beam; a upward directing prism that changes the direction of the optical axis of the laser beam output from the collimator lens by approximately 90°, the upward directing prism having a beam-shaping magnification β in the range of 0.94≦β≦1.06; an objective lens that condenses the laser beam on an optical disc after the direction of the optical axis is changed by the upward directing prism; and a unit for changing an angle of divergence or convergence of the laser beam incident on the objective lens.

A method for reducing astigmatism according to another embodiment of the present invention includes the steps of emitting a laser beam from a light source; causing the emitted light beam to pass through a collimator lens and be incident on a upward directing prism having a beam-shaping magnification β in the range of 0.94≦β≦1.06; and changing an angle of divergence or convergence of the laser beam and condensing the laser beam on an optical disc via the upward directing prism and an objective lens.

As described above, according to the embodiments of the present invention, the beam-shaping magnification β is in the range of 0.97<β<1.03 in the optical pickup apparatus or the optical disc apparatus that includes the upward directing prism and that performs dynamic correction of a spherical aberration. Therefore, astigmatism can be reduced without making it difficult to reduce the size of the apparatuses, and information can be accurately recorded and reproduced without redundancy.

### BRIEF DESCRIPTION OF THE DRAWINGS

FIG. 1 is a perspective view of an optical disc apparatus according to a first embodiment of the present invention;

FIG. 2 is a block diagram illustrating the structure of the optical disc apparatus shown in FIG. 1;

FIG. 3 is a diagram illustrating the structure of an optical pickup shown in FIG. 2;

FIG. 4 is a diagram illustrating an example of a upward directing prism;

FIGS. 5A to 5C are diagrams illustrating the relationship between an objective lens and incident light;

FIG. 6 is a graph showing the relationship between the cover layer thickness and the spherical aberration;

FIG. 7 is a graph showing the relationship between the spherical aberration and the correction power;

FIG. 8 is a schematic diagram illustrating a double-layer Blu-ray disc having two recording layers for recording information thereon;

FIGS. 9A to 9D are graphs showing the simulation results for determining the condition of beam-shaping magnification for limiting the astigmatism variation to 0.07λ rms or less when the numerical aperture of the objective lens is 0.82;

FIGS. 10A to 10D are graphs showing the simulation results for determining the condition of beam-shaping magnification for limiting the astigmatism variation to 0.07λ rms or less when the numerical aperture of the objective lens is 0.85;

FIGS. 11A to 11D are graphs showing the simulation results for determining the condition of beam-shaping magnification for limiting the astigmatism variation to 0.07λ rms or less when the numerical aperture of the objective lens is 0.88; and

FIG. 12 is a table of numerical values showing the results of FIGS. 9D, 10D, and 11D.

### DESCRIPTION OF THE PREFERRED EMBODIMENTS

Embodiments of the present invention will be described below with reference to the accompanying drawings.

### First Embodiment

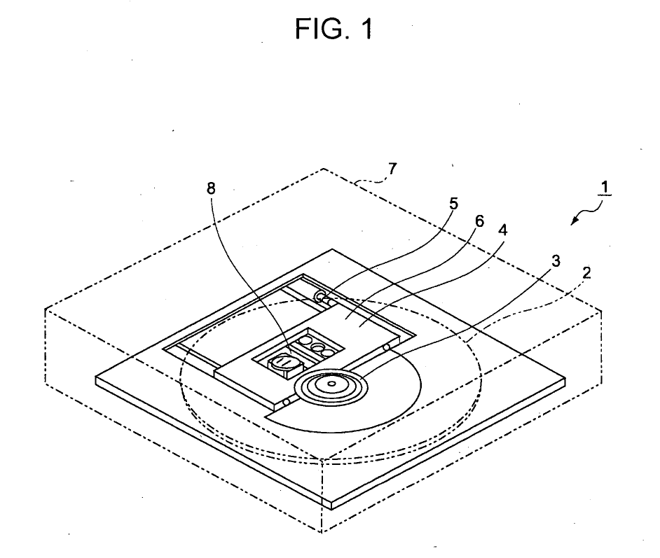

FIG. 1 is a perspective view of an optical disc apparatus 1 according to a first embodiment of the present invention.

The optical disc apparatus 1 shown in FIG. 1 records and reproduces information on and from an optical disc 2 (DVD±R/RW, CD-R/RW, BD, etc.) mounted therein. When the optical disc 2 is a double-layer Blu-ray disc (trademark), the error range of the thickness of each protective layer is determined to be 12.5 μm or less by a standard.

The optical disc apparatus 1 includes a disc table 3 for receiving the optical disc 2, such as a BD, a moveable base 4, a guide shaft 5 for guiding the moveable base 4, an optical pickup 6 for recording and reproducing information on and from the optical disc 2, and a housing 7 for accommodating the above-described components.

The disc table 3 has a chucking mechanism for holding the optical disc 2, and accordingly the disc table 3 can, for example, rotate while the optical disc 2 is attached to the disc table 3.

The moveable base 4 is slidable in, for example, the radial direction of the optical disc 2. The optical pickup 6, a feeding motor, which will be described below, etc., are mounted on the moveable base 4.

The guide shaft 5 guides the moveable base 4 in the radial direction of the optical disc 2.

The optical pickup 6 includes an objective-lens actuator 8, and the objective-lens actuator 8 moves an objective lens, which will be described below, in a focusing direction and a tracking direction to perform focusing servo control and tracking servo control.

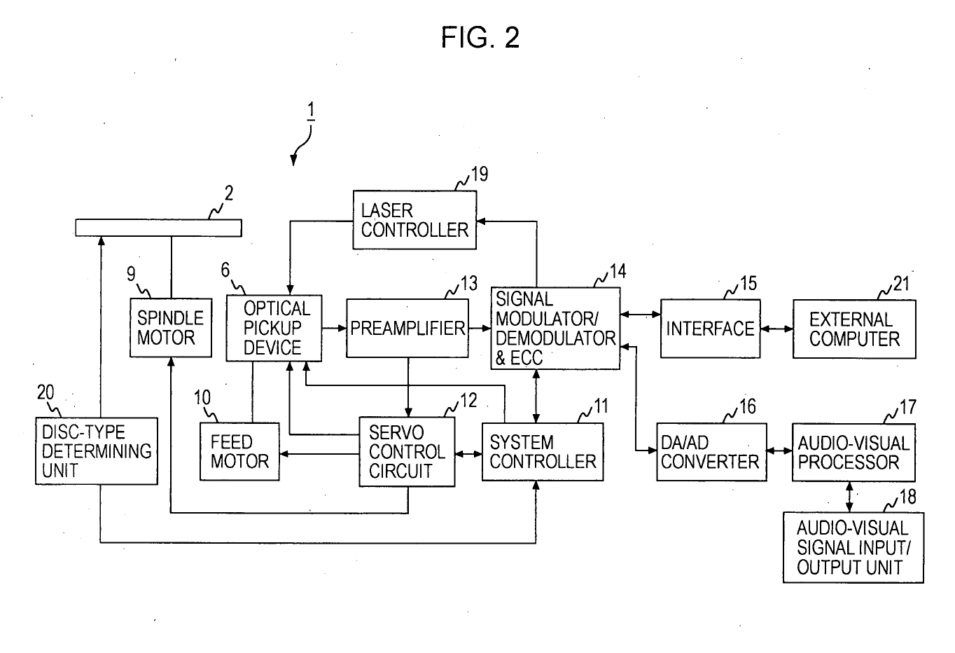

FIG. 2 is a block diagram illustrating the structure of the optical disc apparatus 1 shown in FIG. 1.

As shown in FIG. 2, in addition to the optical pickup 6, the optical disc apparatus 1 further includes a spindle motor 9, a feed motor 10, a system controller 11, a servo control circuit 12, a preamplifier 13, a device 14 that functions as both a signal modulator/demodulator and an error correcting code (ECC) unit, an interface 15, a DA/AD converter 16, an audio-visual processor 17, an audio-visual signal input/output unit 18, a laser controller 19, and a disc-type determining unit 20.

The spindle motor 9 rotates the optical disc 2.

The feed motor 10 moves the moveable base 4 shown in FIG. 1 in the radial direction of the optical disc 2, thereby moving the optical pickup 6 in the radial direction of the optical disc 2.

The system controller 11 controls the overall operation of the optical disc apparatus 1 and individual control operations, such as signal processes and servo control.

The servo control circuit 12 generates a focus servo signal and a tracking servo signal based on signals (a focusing error signal and a tracking error signal) obtained from the preamplifier 13. The thus-generated signals are output to the optical pickup 6 and the feed motor 10.

The preamplifier 13 generates the focus error signal, the tracking error signal, and an RF signal from signals obtained from the optical pickup 6.

The device 14 that functions as both a signal modulator/demodulator and an error correcting code (ECC) unit demodulates the RF signal and a recording signal, and performs an error correction coding process. For example, an ECC is added to a recording signal and error correction is performed for a reproducing signal (RF signal).

The interface 15 communicates signals with an external computer 21.

The DA/AD converter 16 converts a digital reproducing signal into an analog reproducing signal and converts an analog recording signal into a digital recording signal.

The audio-visual processor 17 and the audio-visual signal input/output unit 18 communicate audio signals and video signals with an external device.

The laser controller 19 controls the output and wavelength of a semiconductor laser, which is mounted in the optical pickup 6, in accordance with a recording/reproducing operation, the type of the optical disc 2, etc.

The disc-type determining unit 20 determines the type (e.g., DVD±R/RW, CD-R/RW, and BD) of the optical disc 2 that is mounted in the optical disc apparatus 1.

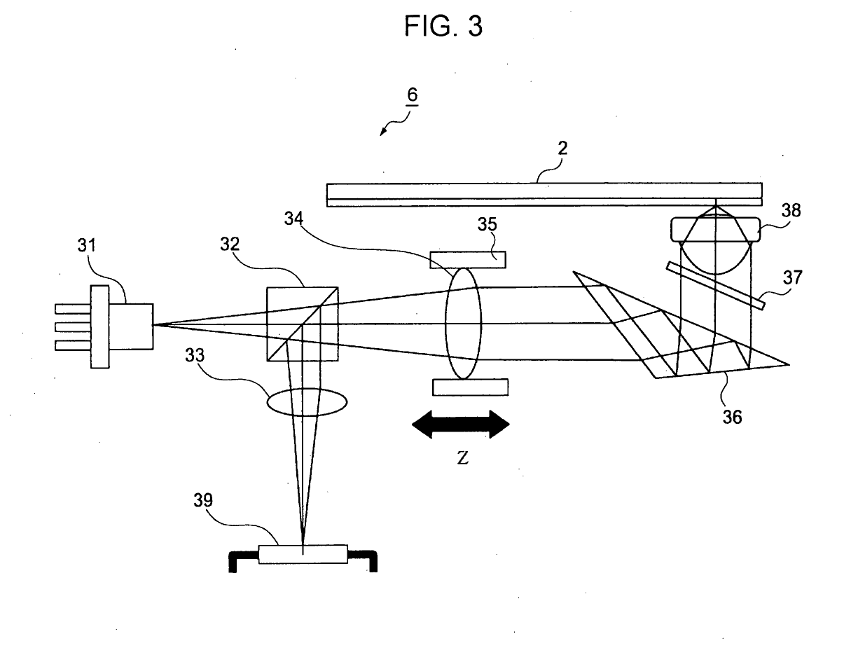

FIG. 3 is a diagram illustrating the structure of the optical pickup 6 shown in FIG. 2.

As shown in FIG. 3, the optical pickup 6 includes a semiconductor laser 31 that functions as a light source, a beam splitter 32, a lens 33, a collimator lens 34, a collimator-lens drive mechanism 35, a upward directing prism 36, a quarter-wave plate 37, an objective lens 38, and a signal-detecting system 39.

The semiconductor laser 31 is a blue semiconductor laser that emits a blue laser beam with a wavelength of 405 nm±10 nm. A light source that can selectively emit a laser beam with a wavelength of 780 nm for CD-R and CD-RW and a laser beam with a wavelength of 650 nm for DVD-R and DVD-RW may, of course, also be used as the semiconductor laser 31.

The beam splitter 32 is an optical element for reflecting returning light that is polarized by 90° to guide the returning light toward the signal-detecting system 39.

The lens 33 condenses light reflected by the beam splitter 32 on the signal-detecting system 39.

The collimator lens 34 is an optical element for collimating the laser beam that passes through the beam splitter 32. The collimator lens 34 also functions to change an angle of divergence or convergence of the laser beam.

The collimator-lens drive mechanism 35 is configured to move the collimator lens 34 along an optical axis (in the Z direction in FIG. 3). The angle of divergence or convergence of the laser beam is changed as the collimator lens 34 moves along the optical axis. The movement of the collimator lens 34 is controlled by, for example, the system controller 11.

The upward directing prism 36 has a triangular prismatic shape, and the cross section thereof is a substantially isosceles triangle with an obtuse vertex angle. The upward directing prism 36 functions as an anamorphic prism. More specifically, when the laser beam passes through the upward directing prism 36, the light intensity distribution thereof is changed to a substantially circular light intensity distribution.

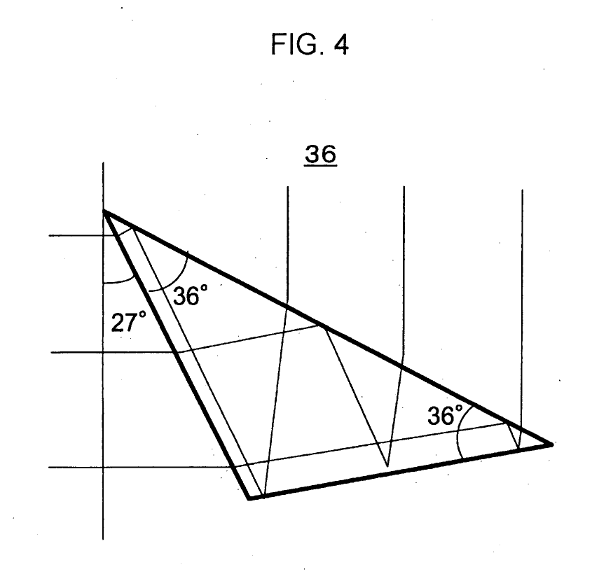

FIG. 4 shows an example of the shape of the upward directing prism 36. The upward directing prism 36 shown in FIG. 4 has a refractive index of 1.469, and an angle between an entrance surface and an exit surface is 36°. In addition, an angle between the exit surface and a surface that is neither the entrance surface nor the exit surface is 36°, and an angle between the entrance surface and a plane perpendicular to the incident light is 27°.

A beam-shaping magnification β of the upward directing prism 36 is in the range of 0.97<β<1.03.

The objective lens 38 has a numerical aperture of, for example, about 0.85, and condenses the laser beam on the optical disc 2.

The signal-detecting system 39 includes a light-receiving element, such as a photodetector (PD) for detecting the intensity of the incident laser beam. The signal-detecting system 39 detects light reflected by the optical disc 2 as a signal. This signal is transmitted to the preamplifier 13. The signal-detecting system 39 also includes a light-receiving element of a servo system.

In an operation of recording a signal on the optical disc 2, the laser beam emitted from the semiconductor laser 31 passes through the beam splitter 32, the collimator lens 34, the upward directing prism 36, the quarter-wave plate 37, and the objective lens 38, and is condensed on the optical disc 2. Accordingly, the signal is recorded on the optical disc 2.

When a signal is reproduced from the optical disc 2, the laser beam emitted from the semiconductor laser 31 passes through the beam splitter 32, the collimator lens 34, the upward directing prism 36, the quarter-wave plate 37, and the objective lens 38, and is condensed on the optical disc 2. Then, light reflected by the optical disc 2 (returning light) passes through the objective lens 38, the quarter-wave plate 37, the upward directing prism 36, the collimator lens 34, the beam splitter 32, and the lens 33, and is condensed on the signal-detecting system 39. Accordingly, the signal is detected by the signal-detecting system 39.

The reason why the beam-shaping magnification β of the upward directing prism 36 is set within the range of 0.97<1.03 will be described below.

If the beam-shaping magnification β of the upward directing prism 36 is in the range of about 1.1 and 1.3 as commonly reported, large astigmatism occurs in the case in which the spherical aberration correction is additionally performed. This is because when the spherical aberration due to thickness error of a protective layer (cover), which functions as a light incident layer of the optical disc, is corrected, diverging light or converging light passes through the prism. In addition, when the optical disc is a multi-layer disc, such as a double-layer disc, the cover thickness differs for each layer. Therefore, the angle of divergence or convergence is changed depending on the layer to be accessed, and the astigmatism is also changed accordingly.

Therefore, the beam-shaping magnification β of the upward directing prism 36 is preferably around 1.0.

The angle of divergence or convergence of the light beam incident on the objective lens 38 differs in accordance with an amount of correction of the thickness of the protective layer (cover glass (the concept of the term “glass” used herein includes polycarbonate, acrylic resin, and other kinds of resin)), which functions as a light incident layer of the optical disc. Accordingly, the power of spherical aberration also differs. The astigmatism is determined by the power of spherical aberration and the beam-shaping magnification β as follows:

$$\begin{matrix}Astigmatism = a \times Power ( rms ) \times ( 1 - β ) \\ = b \times ( Amount of Correction of Cover Glass \\ Thickness ) \times ( 1 - β )\end{matrix} \\ \begin{matrix}β = 1 - c \times Astigmatism / ( Amount of Correction of Cover \\ Glass Thickness )\end{matrix} \qquad ( 1 )$$

where
a: proportionality coefficient
b: proportionality coefficient
c: proportionality coefficient (c=1/b)
   For example, a case is considered in which the optical disc is a double-layer BD. When the amount of correction of the cover glass thickness is ±12.5 μm, the wavelength λ of the laser beam is 405 nm, and the numerical aperture NA of the objective lens 38 is 0.85, the power of the diverging light or the converging light incident on the objective lens 38 is ±1.68λ rms.

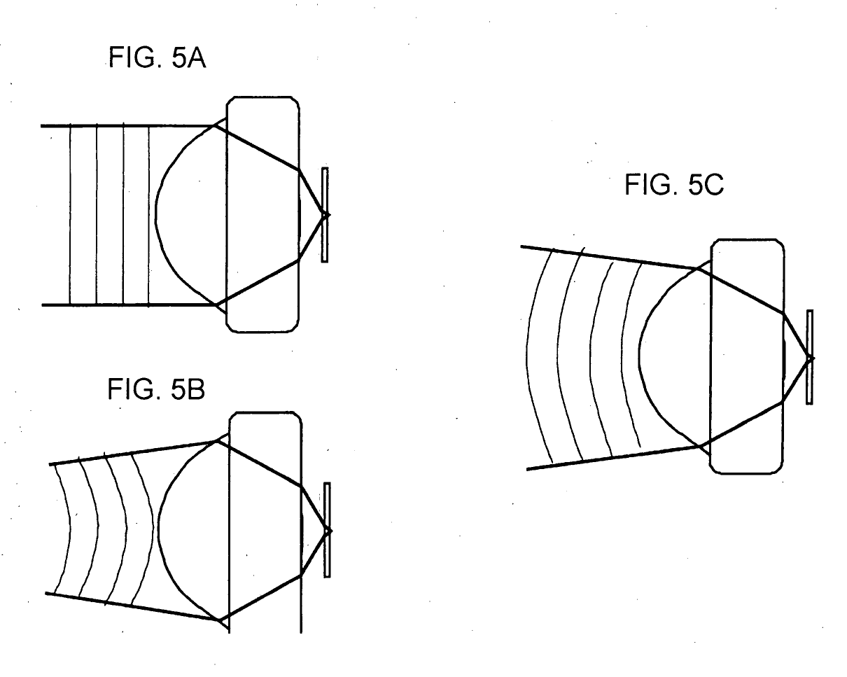

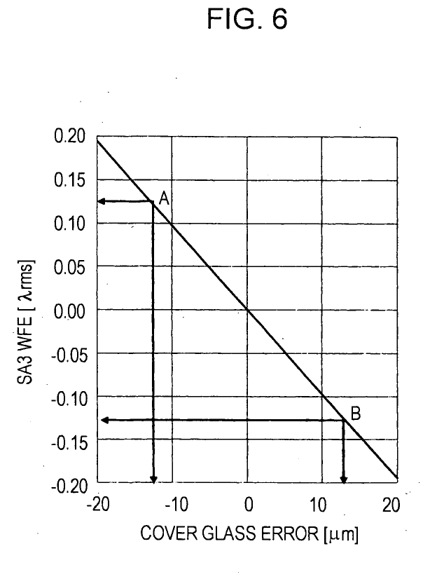

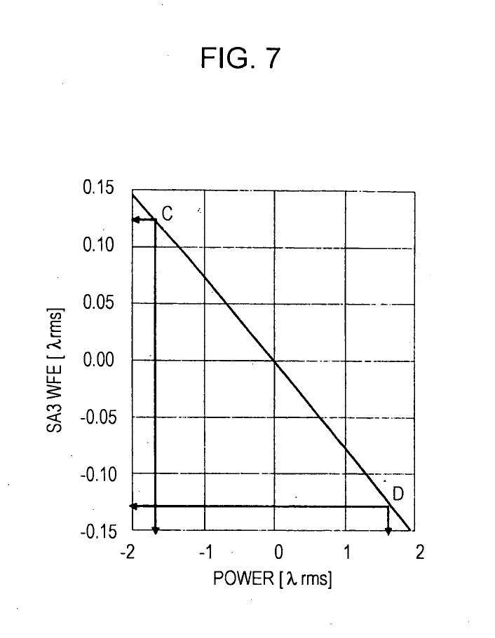

The power of the diverging light or the converging light incident on the objective lens 38 is determined to be ±1.68λ rms from a simulation described below. Referring to FIGS. 5A to 5C, the power is defined to be 0 when parallel light is incident on the objective lens 38, negative when diverging light is incident on the objective lens 38, and positive when converging light is incident on the objective lens 38. In this case, as shown in FIG. 6, the three-dimensional spherical aberration SA3 WFE that occurs when the error in the cover glass thickness is ±12.5 μm is simulated as ±0.125λ rms (points A and B in FIG. 6). Accordingly, as shown in FIG. 7, the power for correcting the spherical aberration SA3 WFE of ±0.125λ rms is determined as ±1.68λ rms (points C and D).

In this case, to reduce the astigmatism AS·λ rms to or below the Marechal criterion, i.e., 0.07λ rms, the beam-shaping magnification β preferably satisfies the following expression:
0.97<β<1.03
Accordingly, c=0.0054 is generally set in Equation (1).

The Marechal criterion is determined on the basis of a ratio of the maximum intensity of a point image formed by a currently used lens to the maximum intensity of a point image formed by an ideal lens. The Marechal criterion is given as MD>0.8 when MD is given as follows:
MD=(1−2π²/λ²·W)²
where
MD: Marechal criterion value
λ: wavelength
W: RMS value of wavefront aberration
   since RMS=W^{1/2}, RMS is to be equal to or below the Marechal criterion 0.07λ rms.

In the optical disc apparatus 1 having the above-described structure, it is assumed that, for example, the optical disc 2 is a double-layer BD and the numerical aperture of the objective lens 38 is about 0.85. In this case, the spherical aberration that occurs when the laser beam is focused on each layer differs between the layers. Therefore, in the optical disc apparatus 1, the collimator lens 34 is moved along the optical axis to change the angle of divergence or convergence of the laser beam incident on the upward directing prism 36, thereby adaptively controlling the amount of correction of the spherical aberration.

However, in the optical disc apparatus 1 whose size is reduced by using the upward directing prism 36, if the beam-shaping magnification β of the upward directing prism 36 is set to about 1.1 to 1.3 as in the known structure, the astigmatism occurs due to the upward directing prism 36.

Therefore, in the optical disc apparatus 1 according to the present embodiment, the beam-shaping magnification β of the upward directing prism 36 is set so as to satisfy the following expression:
0.97<β<1.03
Accordingly, the upward directing prism 36 does not cause the astigmatism.

Since the optical disc apparatus 1 does not use any additional components, the astigmatism can be reduced without making it difficult to reduce the size of the optical disc apparatus 1. In addition, the optical disc apparatus 1 can accurately record and reproduce information without redundancy.

### Other Embodiments

The present invention is not limited to the above-described embodiment, and various modifications are possible within the scope of the technical idea of the present invention. Such modifications are, of course, also included in the technical scope of the present invention.

For example, the present invention may also be applied to an optical disc apparatus dedicated to reproducing information or an optical disc apparatus dedicated to recording information.

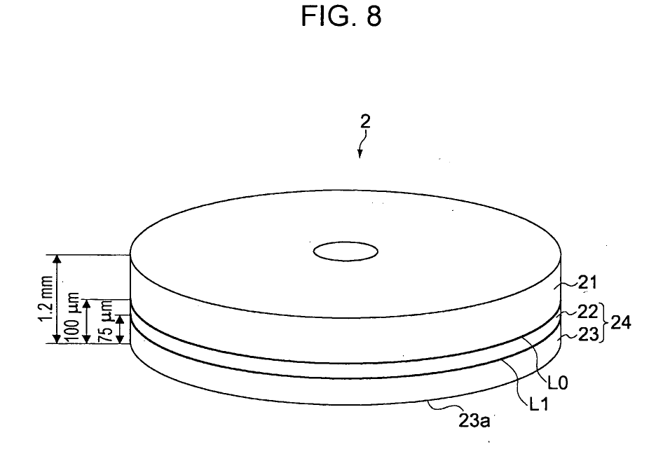

The “thickness of the cover glass” of the BD will be described in more detail below. FIG. 8 is a schematic diagram illustrating a BD 2 having two recording layers for recording information thereon (hereafter called a double-layer BD). The double-layer BD 2 includes a substrate 21, and an L0 layer, which functions as a first recording layer, is formed on the substrate 21. An intermediate layer 22 is provided on the L0 layer, and an L1 layer, which functions as a second recording layer, is formed on the intermediate layer 22 on the side opposite to the L0 layer. A cover layer 23 is provided on the L1 layer. The “cover glass” mentioned above includes the cover layer 23 and the intermediate layer 22 for the L0 layer, and includes only the cover layer 23 for the L1 layer. Accordingly, the “thickness of the cover glass” is equal to the sum of the thickness of the cover layer 23 and the thickness of the intermediate layer 22 for the L0 layer, and is equal to the thickness of the cover layer 23 for the L1 layer.

The design values of the double-layer BD 2 are provided as follows:
(1) Depth of the L0 layer from a surface 23a of the cover layer 23 (surface of the double-layer BD 2): 100 μm±5 μm (hereinafter, ±5 μm is the allowable error)
(2) Depth of the L1 layer from the surface 23a of the cover layer 23: 75 μm±5 μm
(3) Thickness of the intermediate layer 22: 25 μm±5 μm
(4) Overall thickness of the double-layer BD 2: 1.2 mm±predetermined allowable error.

According to the design value (3), the distance between the L0 layer and the L1 layer is determined as 25 μm±5 μm. Thus, one-half of this value, i.e., 12.5 μm is determined as the intermediate value of the thickness of the intermediate layer 22. The above-mentioned “amount of correction of the cover glass thickness” corresponds to the distances from the center of the intermediate layer 22 to the L0 and L1 layers in the thickness direction, and is determined as ±12.5 μm. The center of the intermediate layer 22 in the thickness direction thereof is at the depth of 87.5 μm from the surface 23a of the cover layer 23.

Since the allowable error for the design values (1) and (2) is ±5 μm, the allowable range of the depth of the L0 layer is 95 μm to 105 μm and that of the L1 layer is 70 μm to 80 μm. Therefore, the maximum thickness of the intermediate layer 22 is calculated as 105−70=35 μm, and the minimum thickness thereof is calculated as 95−80=15 μm. In other words, the maximum range of the thickness of the intermediate layer 22 is 15 μm to 35 μm. However, in practice, since the thickness of the intermediate layer 22 is 25 μm±5 μm according to the design value (3), the thickness of the intermediate layer 22 is not set to 15 μm or 35 μm in practice. However, since the optical pickup is preferably capable of complying with multiple double-layer BDs, the maximum range of 15 μm to 35 μm is considered as the thickness range of the double-layer BD 2.

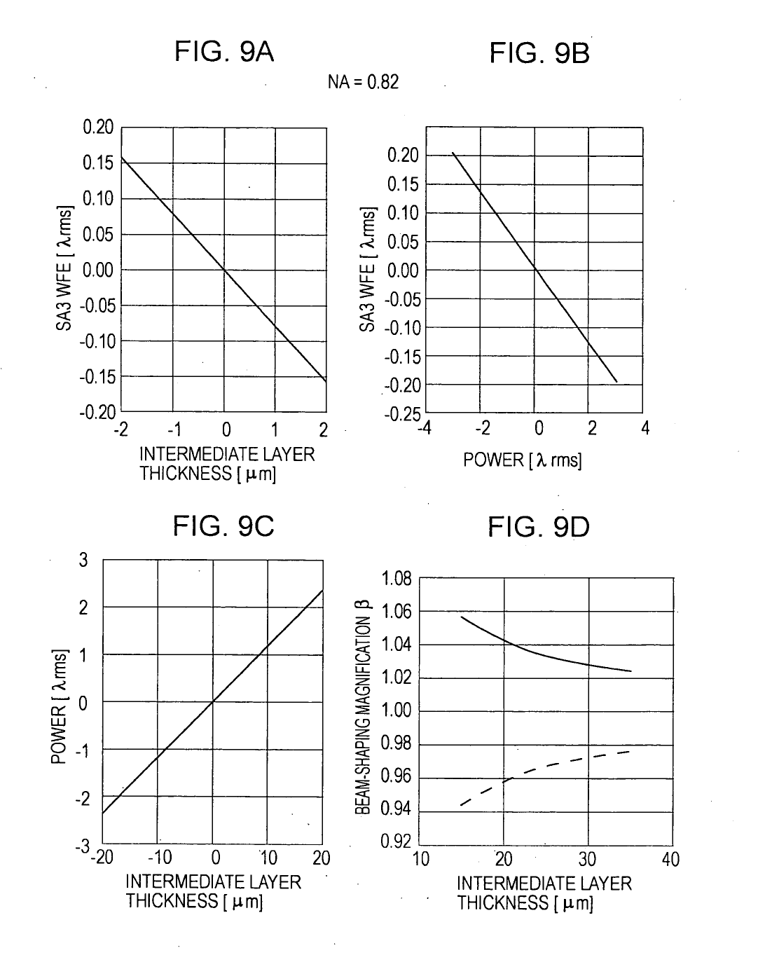

FIGS. 9A to 9D, FIGS. 10A to 10D, and FIGS. 11A to 11D are graphs showing the results of simulations for determining the condition of the beam-shaping magnification β for limiting the variation in the astigmatism of the laser beam emitted from the prism 36 toward the objective lens 38 to 0.07λ rms or less. FIGS. 9A to 9D, FIGS. 10A to 10D, and FIGS. 11A to 11D show the results obtained when the numerical aperture NA of the objective lens 38 is 0.82, 0.85, and 0.88, respectively, and when the power of the laser beam incident on the upward directing prism 36 is varied to correct the three-dimensional spherical aberration in accordance with the thickness of the intermediate layer 22.

More specifically, FIG. 9A shows the relationship between the thickness of the intermediate layer 22 and the three-dimensional spherical aberration. FIG. 9B shows the relationship between the power of the diverging or converging laser beam to be incident on the objective lens 38 and the three-dimensional spherical aberration. FIG. 9C shows the relationship between the thickness of the intermediate layer 22 and the above-mentioned power. FIG. 9D shows the relationship between the thickness of the intermediate layer 22 and the beam-shaping magnification β at which the variation in the astigmatism is equal to the Marechal criterion 0.07λ rms.

In FIGS. 9A and 9C, the thickness of the intermediate layer 22 is shown by negative or positive values. These values show the thickness of the intermediate layer 22 when the intermediate value of the thickness of the intermediate layer 22 (the absolute value of the thickness is 25 μm) is defined as 0. In FIG. 9D, the thickness of the intermediate layer 22 is shown by the absolute value thereof. FIGS. 9A and 9B are obtained as a result of optical simulations, FIG. 9C is a graph obtained on the basis of the results shown in FIGS. 9A and 9B, and FIG. 9D is a graph obtained on the basis of the result shown in FIG. 9C.

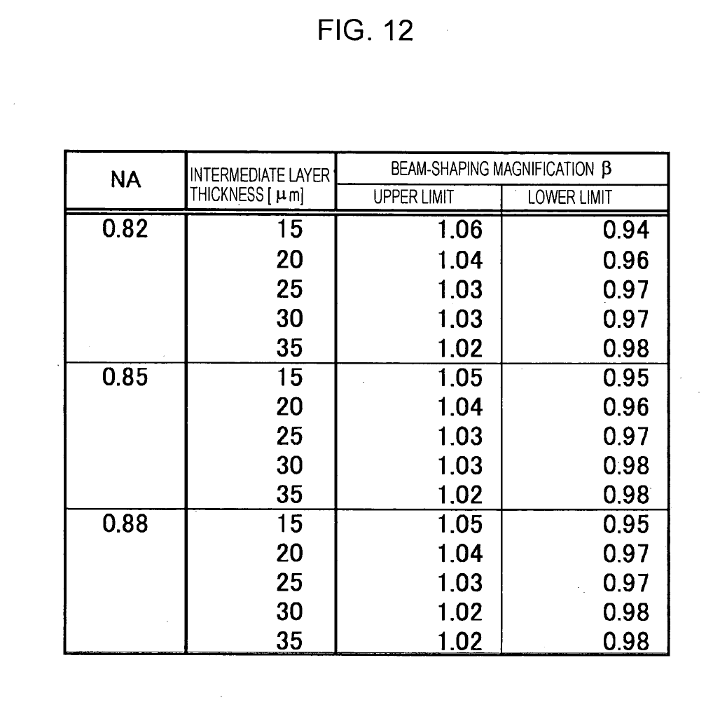

When, for example, the absolute value of the thickness of the intermediate layer 22 is at a minimum and is 15 μm, that is, when the thickness of the intermediate layer 22 is ±7.5 μm in FIG. 9A, the three-dimensional spherical aberration is about ±0.059λ rms. In this case, the power is determined to be about ±0.88λ rms from FIG. 9B. From these results, the graph shown in FIG. 9C is obtained. The power of light incident on the upward directing prism in accordance with the thickness of the intermediate layer 22 is determined from FIG. 9C. Accordingly, the astigmatism of light emitted from the prism varies in accordance with the thickness of the intermediate layer 22, and the condition of the beam-shaping magnification β at which the astigmatism is equal to or less than the Marechal criterion 0.07λ rms is determined as shown in FIG. 9D. In FIG. 9D, the solid line and the dashed line show the beam-shaping magnifications β at which the astigmatism is equal to the Marechal criterion 0.07λ rms. The astigmatism is less than 0.07λ rms in the region between the solid line and the dashed line, and is more than 0.07λ rms in the region outside the solid line and the dashed line. Thus, the solid line and the dashed line correspond to the upper limit and the lower limit, respectively, of the beam-shaping magnification β for limiting the astigmatism to the Marechal criterion 0.07λ rms or less. FIG. 12 is a table of numerical values showing the result of FIG. 9D.

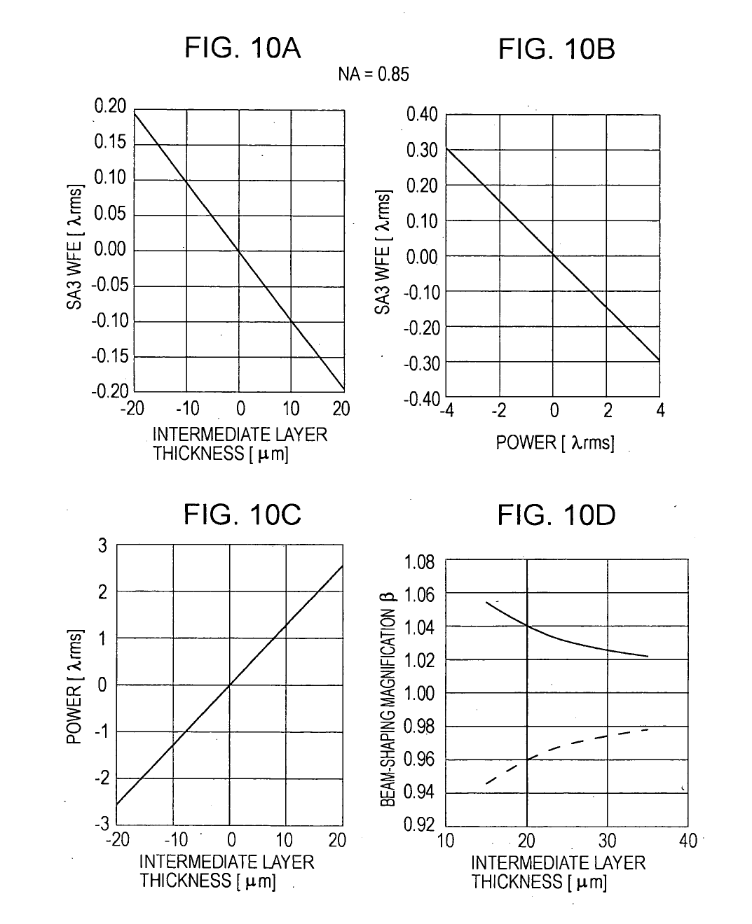

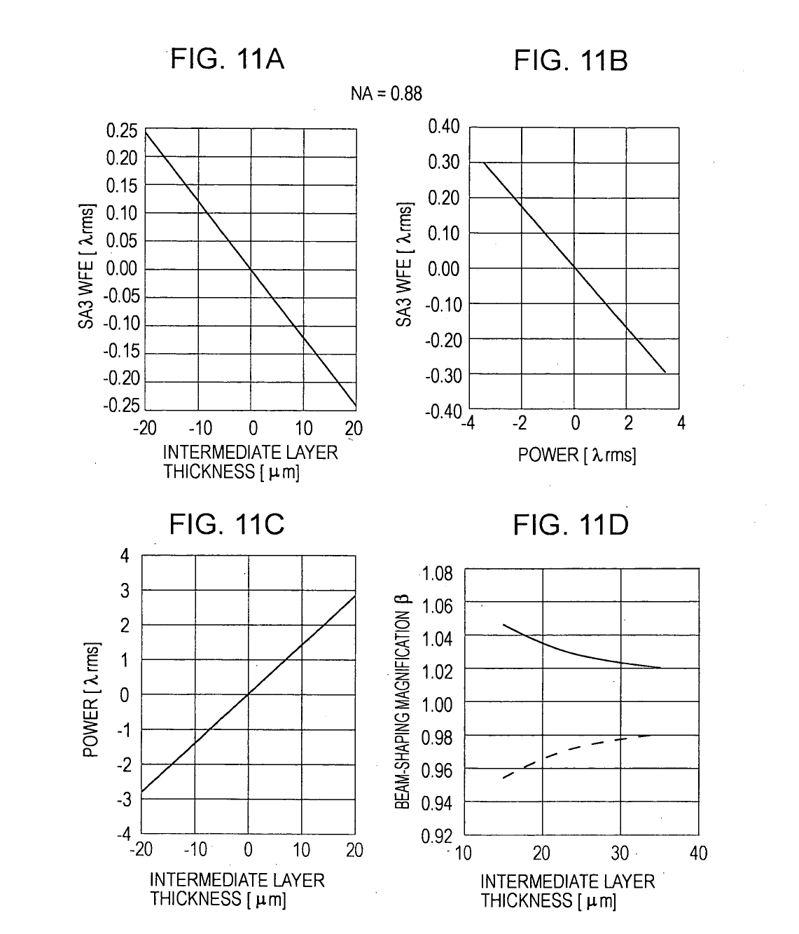

The results of FIGS. 10A to 10D obtained when the numerical aperture NA is 0.85 and FIGS. 11A to 11D obtained when the numerical aperture NA is 0.88 are also shown in the table of FIG. 12. As is clear from FIG. 12, with respect to the range of the beam-shaping magnification β, 0.94≦β≦1.06 may be applied to all of the numerical apertures 0.82, 0.85, and 0.88. The relationship between the thickness of the intermediate layer 22 and the beam-shaping magnification β does not vary in accordance with the numerical aperture NA. In other words, the beam-shaping magnification β does not greatly depend on the numerical aperture NA.

As described above, according to the present embodiment, the beam-shaping magnification β is set in the range of 0.94≦β≦1.06, and the number of components is not increased. Therefore, the astigmatism can be reduced without making it difficult to reduce the size of the apparatus.

Although the BD is described above as an example of a high-density optical disc, the present invention may also be applied to other kinds of optical discs, such as high definition DVDs (HD-DVDs).

It should be understood by those skilled in the art that various modifications, combinations, sub-combinations and alterations may occur depending on design requirements and other factors insofar as they are within the scope of the appended claims or the equivalents thereof.

What is claimed is:

1. An optical disc apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.97<β<1.03;
an objective lens that condenses the laser beam on an optical disc after the direction of the optical axis is changed by the upward directing prism, the optical disc having a protective layer with a thickness error range of 12.5 μm, the objective lens having a numerical aperture NA of 0.85; and
means for changing an angle of divergence or convergence of the laser beam incident on the objective lens.

2. The optical disc apparatus according to claim 1, wherein a refractive index of the upward directing prism is 1.469, an angle between an entrance surface and an exit surface of the upward directing prism is 36°, an angle between the exit surface and a surface of the upward directing prism that is neither the entrance surface nor the exit surface is 36°, and an angle between the entrance surface and a plane perpendicular to the laser beam incident on the upward directing prism is 27°.

3. The optical disc apparatus according to claim 1, wherein a wavelength of the laser beam emitted from the light source is 405 nm±10 nm.

4. The optical disc apparatus according to claim 1, wherein the means for changing the angle of divergence or convergence of the laser beam incident on the objective lens includes a mechanism for moving the collimator lens along the optical axis.

5. An optical disc apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.94≦β≦1.06;
an objective lens that condenses the laser beam on an optical disc after the direction of the optical axis is changed by the upward directing prism; and
means for changing an angle of divergence or convergence of the laser beam incident on the objective lens.

6. The optical disc apparatus according to claim 5, wherein a refractive index of the upward directing prism is 1.469, an angle between an entrance surface and an exit surface of the upward directing prism is 36°, an angle between the exit surface and a surface of the upward directing prism that is neither the entrance surface nor the exit surface is 36°, and an angle between the entrance surface and a plane perpendicular to the laser beam incident on the upward directing prism is 27°.

7. The optical disc apparatus according to claim 5, wherein a wavelength of the laser beam emitted from the light source is 405 nm±10 nm.

8. The optical disc apparatus according to claim 5, wherein the means for changing the angle of divergence or convergence of the laser beam incident on the objective lens includes a mechanism for moving the collimator lens along the optical axis.

9. An optical pickup apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.97≦β≦1.03;
an objective lens that condenses the laser beam on an optical disc after the direction of the optical axis is changed by the upward directing prism, the optical disc having a protective layer with a thickness error range of 12.5 μm, the objective lens having a numerical aperture NA of 0.85; and
means for changing an angle of divergence or convergence of the laser beam incident on the objective lens.

10. The optical pickup apparatus according to claim 9, wherein a refractive index of the upward directing prism is 1.469, an angle between an entrance surface and an exit surface of the upward directing prism is 36°, an angle between the exit surface and a surface of the upward directing prism that is neither the entrance surface nor the exit surface is 36°, and an angle between the entrance surface and a plane perpendicular to the laser beam incident on the upward directing prism is 27°.

11. The optical pickup apparatus according to claim 9, wherein a wavelength of the laser beam emitted from the light source is 405 nm±10 nm.

12. The optical pickup apparatus according to claim 9, wherein the means for changing the angle of divergence or convergence of the laser beam incident on the objective lens includes a mechanism for moving the collimator lens along the optical axis.

13. An optical pickup apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.94≦β≦1.06;
an objective lens that condenses the laser beam on an optical disc after the direction of the optical axis is changed by the upward directing prism; and means for changing an angle of divergence or convergence of the laser beam incident on the objective lens.

14. The optical pickup apparatus according to claim 13, wherein a refractive index of the upward directing prism is 1.469, an angle between an entrance surface and an exit surface of the upward directing prism is 36°, an angle between the exit surface and a surface of the upward directing prism that is neither the entrance surface nor the exit surface is 36°, and an angle between the entrance surface and a plane perpendicular to the laser beam incident on the upward directing prism is 27°.

15. The optical pickup apparatus according to claim 13, wherein a wavelength of the laser beam emitted from the light source is 405 nm±10 nm.

16. The optical pickup apparatus according to claim 13, wherein the means for changing the angle of divergence or convergence of the laser beam incident on the objective lens includes a mechanism for moving the collimator lens along the optical axis.

17. A method for reducing astigmatism, comprising the steps of:
emitting a laser beam from a light source;
causing the emitted light beam to pass through a collimator lens and be incident on a upward directing prism having a beam-shaping magnification β in the range of 0.97<β<1.03; and
changing an angle of divergence or convergence of the laser beam and condensing the laser beam on an optical disc via the upward directing prism and an objective lens, the optical disc having a protective layer with a thickness error range of 12.5 μm, the objective lens having a numerical aperture NA of 0.85.

18. The method for reducing astigmatism according to claim 17, wherein a refractive index of the upward directing prism is 1.469, an angle between an entrance surface and an exit surface of the upward directing prism is 36°, an angle between the exit surface and a surface of the upward directing prism that is neither the entrance surface nor the exit surface is 36°, and an angle between the entrance surface and a plane perpendicular to the laser beam incident on the upward directing prism is 27°.

19. The method for reducing astigmatism according to claim 17, wherein a wavelength of the laser beam emitted from the light source is 405 nm±10 nm.

20. The method for reducing astigmatism according to claim 17, wherein the angle of divergence or convergence of the laser beam incident on the objective lens is changed by moving the collimator lens along an optical axis.

21. A method for reducing astigmatism, comprising the steps of:
emitting a laser beam from a light source;
causing the emitted light beam to pass through a collimator lens and be incident on a upward directing prism having a beam-shaping magnification β in the range of 0.94≦β≦1.06; and
changing an angle of divergence or convergence of the laser beam and condensing the laser beam on an optical disc via the upward directing prism and an objective lens.

22. The method for reducing astigmatism according to claim 21, wherein a refractive index of the upward directing prism is 1.469, an angle between an entrance surface and an exit surface of the upward directing prism is 36°, an angle between the exit surface and a surface of the upward directing prism that is neither the entrance surface nor the exit surface is 36°, and an angle between the entrance surface and a plane perpendicular to the laser beam incident on the upward directing prism is 27°.

23. The method for reducing astigmatism according to claim 21, wherein a wavelength of the laser beam emitted from the light source is 405 nm±10 nm.

24. The method for reducing astigmatism according to claim 21, wherein the angle of divergence or convergence of the laser beam incident on the objective lens is changed by moving the collimator lens along an optical axis.

25. An optical disc apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.97<β<1.03;
an objective lens that condenses the laser beam on an optical disc having a protective layer with a thickness error range of 12.5 μm after the direction of the optical axis is changed by the upward directing prism, the objective lens having a numerical aperture NA of 0.85; and
a unit for changing an angle of divergence or convergence of the laser beam incident on the objective lens.

26. An optical disc apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.94≦β≦1.06;
an objective lens that condenses the laser beam on an optical disc after the direction of the optical axis is changed by the upward directing prism; and
a unit for changing an angle of divergence or convergence of the laser beam incident on the objective lens.

27. An optical pickup apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.97<β<1.03;
an objective lens that condenses the laser beam on an optical disc after the direction of the optical axis is changed by the upward directing prism, the optical disc having a protective layer with a thickness error range of 12.5 μm, the objective lens having a numerical aperture NA of 0.85; and
a unit for changing an angle of divergence or convergence of the laser beam incident on the objective lens.

28. An optical pickup apparatus comprising:
a light source that emits a laser beam;
a collimator lens arranged on an optical axis of the emitted laser beam;
a upward directing prism that changes the direction of the optical axis of the laser beam output from the collimator lens by approximately 90°, the upward directing prism having a beam-shaping magnification β in the range of 0.94≦β≦1.06;
an objective lens that condenses the laser beam on an optical disc after the direction of the optical axis is changed by the upward directing prism; and
a unit for changing an angle of divergence or convergence of the laser beam incident on the objective lens.
